(19) United States
(12) Patent Application Publication
(10) Pub. No.: US 2016/0199939 A1
(43) Pub. Date: Jul. 14, 2016

(54) HOT WIRE LASER CLADDING PROCESS AND CONSUMABLES USED FOR THE SAME

(71) Applicant: LINCOLN GLOBAL, INC., City of Industry, CA (US)

(72) Inventor: Dennis K. Hartman, North Ridgeville, OH (US)

(21) Appl. No.: 14/969,457

(22) Filed: Dec. 15, 2015

Related U.S. Application Data
(60) Provisional application No. 62/101,511, filed on Jan. 9, 2015.

(51) Int. Cl. B23K 26/342; B23K 26/32; B23K 26/00

(52) U.S. Cl. CPC B23K 26/342; B23K 26/0081; B23K 26/32

(57) ABSTRACT

The invention described herein generally pertains to an improved process in the field of hot wire laser cladding, the improvement comprising adding increased amounts of a deoxidizing metal into the electrode, the deoxidizing metal selected from the group consisting of at least one of Al, Ti, Si, Mn and Zr, the addition of the increased amount of the deoxidizing metal increasing the cladding rate by at least 10-30%.

### PRIORITY

The present application claims priority to U.S. Provisional Application No. 62/101,511 filed on Jan. 9, 2015, which is incorporated herein by reference in its entirety.

### TECHNICAL FIELD

The invention described herein pertains generally to an improved process in the field of hot wire laser cladding, and in particular laser cladding on pipes/tubes or curved surfaces.

### BACKGROUND OF THE INVENTION

Cladding is a well-established process used in a variety of industries for improving the surface and near-surface properties (e.g., wear, corrosion or heat resistance) of a part, or to resurface a component that has become worn through use. Cladding specifically involves the creation of a new surface layer having a different composition from that of the base material.

Cladding technologies can be broadly classified into three categories: arc welding; thermal spraying; and laser-based methods. Each of these methods has advantages and limitations.

Laser cladding is conceptually similar to arc welding methods, but the laser is used to melt the surface of the substrate and the clad material, which can be in the wire, strip or powder form. Laser cladding is commonly performed with CO₂, various types of Nd:YAG, and more recently, fiber lasers.

Laser cladding typically produces a high quality clad, that is a clad having low dilution, low porosity and good surface uniformity. Laser cladding produces minimal heat input on the part, which largely eliminates distortion and the need for post-processing, and avoids the loss of alloying elements or hardening of the base material. In addition, the rapid natural quench experienced with laser cladding results in a fine grain structure in the clad layer.

An exemplary laser cladding process combines preheated gas metal arc welding (“GMAW”) wire with a multikilowatt, solid-state, fiber delivered laser. A programmable GMAW power source can be used to heat the wire only and the electricity is shorted to prevent a traditional arc. The power source can use software that synchronizes the heating power with the laser control. The preheated wire, which feeds at a specified angle to the laser beam, reduces the power requirements from the laser, just enough to lay down the clad and let it flow, but not so much as to cause excess dilution. The result is a cladding process with dilution properties similar to powder laser cladding and with the advantages of using a wire, including out-of-position capability.

However, even with the above advantages, deposition rates for cylindrical pipe/tube were limited, and in the cladding industry, the ability to deposit cladding material at faster rates is very important.

### SUMMARY OF THE INVENTION

In accordance with the present invention, there is provided a process to increase the cladding speed of a high nickel content welding wire which meets AWS ERNiCrMo-10 standards and has less than 0.03 wt % Al, the improvement comprising: adding additional Al to the welding wire so that the total amount of Al is at least 0.05 wt. % Al, said process further comprising increasing the rotational speed of a substrate to be cladded by at least 10% in comparison to said process employing a welding wire which meets AWS ERNiCrMo-10 standards and has less than 0.03 wt % Al.

In another aspect of the invention, there is provided a process to increase the cladding speed of a high nickel content welding wire which meets AWS ERNiCrMo-10 standards and has less than 0.03 wt % Al, the improvement comprising: adding additional Al to the welding wire so that the total amount of Al is at least 0.10 wt. % Al, said process further comprising increasing the rotational speed of a substrate to be cladded by at least 15% in comparison to said process employing a welding wire which meets AWS ERNiCrMo-10 standards and has less than 0.03 wt % Al.

In yet another aspect of the invention, there is provided a process to increase the cladding speed of a high nickel content welding wire which meets AWS ERNiCrMo-10 standards and has less than 0.03 wt % Al, the improvement comprising: adding additional Al to the welding wire so that the total amount of Al is at least 0.15 wt. % Al, said process further comprising increasing the rotational speed of a substrate to be cladded by at least 20% in comparison to said process employing a welding wire which meets AWS ERNiCrMo-10 standards and has less than 0.03 wt % Al.

In still yet another aspect of the invention, there is provided a process to increase the cladding speed of a high nickel content welding wire which meets AWS ERNiCrMo-10 standards and has less than 0.03 wt % Al, the improvement comprising: adding additional Al to the welding wire so that the total amount of Al is at least 0.15 wt. % Al, said process further comprising increasing the rotational speed of a substrate to be cladded by at least 30% in comparison to said process employing a welding wire which meets AWS ERNiCrMo-10 standards and has less than 0.03 wt % Al.

In a further aspect of the invention, there is provided a process to increase the cladding speed of a high nickel content welding wire which meets AWS ERNiCrMo-10 standards and has less than 0.03 wt % Al, the improvement comprising: adding additional deoxidizing metals to the welding wire so that the total amount of deoxidizing metal is at least 10% higher in at least one of Al, Ti, Si, Mn and Zr compared to the specifications for a standard AWS ERNiCrMo-10 electrode, and wherein the welding electrode has less than 0.10 wt. % Al, 0.015 wt. % Ti, 0.01 wt. % Si, 0.14 wt. % Mn and 0.001 wt. % Zr, said process further comprising increasing the rotational speed of a substrate to be cladded by at least 20% in comparison to said process employing a welding wire which meets AWS ERNiCrMo-10 standards and has less than 0.03 wt % Al.

In one specific embodiment, there is provided a process to increase the cladding speed of a high nickel content welding wire which meets AWS ERNiCrMo-10 standards and has less than 0.03 wt % Al, the improvement comprising a welding wire having the following weight percentages of elements:

| | Techalloy ® 622 | Techalloy ® 622 | Techalloy ® 622 |
|---|---|---|---|
| | specifications | typical | reformulated |
| | AWS ERNiCrMo-10 | composition | composition |
| % C | 0.015% max | 0.009% | 0.011% |
| % Mn | 0.0% | 0.21% | 0.14% |
| % Fe | 2.0-6.0% | 4.56% | 4.42-4.59% |
| % P | 0.02% max | 0.002% | 0.003-0.004% |
| % S | 0.010% max | 0% | 0% |
| % Si | 0.08% max | 0.03% | 0.01% |
| % Cu | 0.50% max | 0.002% | 0.002% |
| % Ni | Balance | 56.40% | 56.52-57.05% |
| % Co | 2.50% max | 0.027% | 0.062-0.065% |
| % Cr | 20.0-22.5% | 21.81% | 21.28-21.50% |
| % Mo | 12.5-14.5% | 13.6% | 13.4-13.8% |
| % V | 0.35% max | 0.027% | 0.023-0.024% |
| % W | 2.5-3.5% | 3.22% | 3.31% |
| % Other | 0.50% max | Bal. | Bal. |
| % Al | — | 0.022% | 0.154-0.157% |

The process can further include increasing the rotational speed of a substrate to be cladded by at least 20% in comparison to the process employing a welding wire which meets AWS ERNiCrMo-10 standards and has less than 0.03 wt % Al.

These and other objects of embodiments of this invention will be evident when viewed in light of the drawings, detailed description and appended claims.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of an exemplary embodiment of a system of the present invention; and

FIG. 2 is a diagrammatical representation of a further view of a cladding process of embodiments of the present invention.

### DETAILED DESCRIPTION OF THE INVENTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

It is noted that the following discussion of exemplary embodiments of the invention are discussed and described in the context of cladding a pipe/tube or curved surface. However, other exemplary embodiments can be applied to all types of surfaces to be clad, and embodiments of the present invention are not limited in this regard. Further, the following discussions focus on exemplary embodiments using a laser to provide heat for the cladding operation. However, in other exemplary embodiments, other heat sources can be used. It is additionally noted that the references herein to weight percent of particular elements or compositions are weight percentages of the entire electrode/consumable.

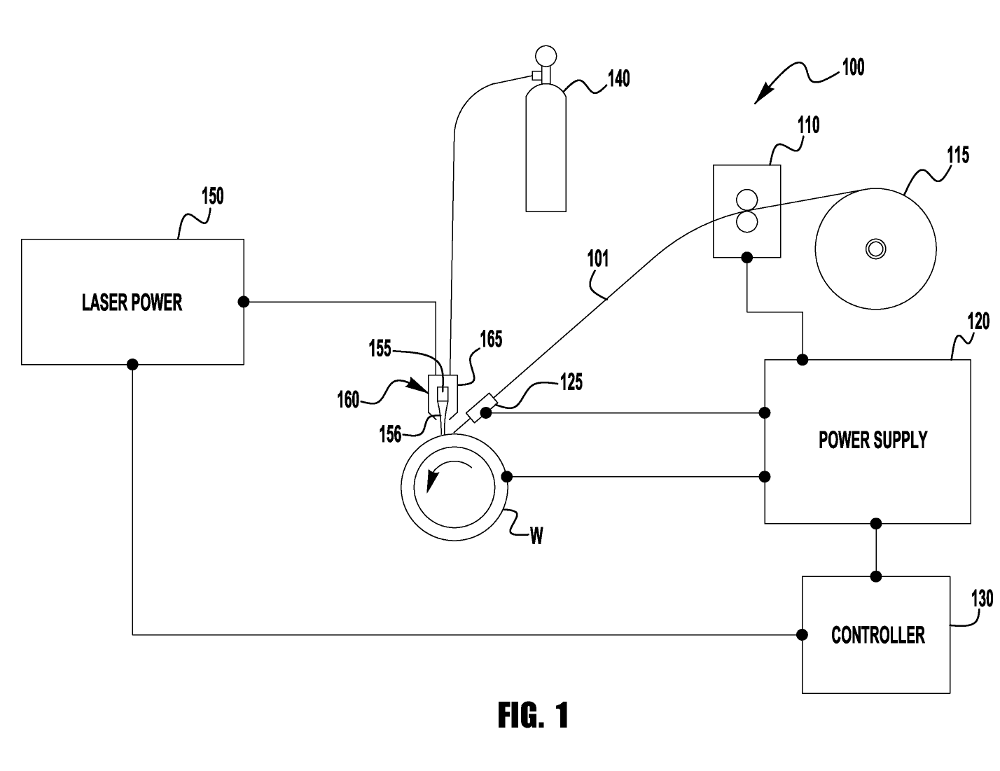

Turning now to FIG. 1, an exemplary cladding system 100 of the present invention is shown. The system 100 depicted is constructed similar to known laser-cladding systems. The system 100 includes a wire feeder 110 which feeds a wire/consumable 101 from a wire source 115 to deliver the wire 101 to the cladding operation. A power supply 120 is coupled to the wire feeder 110, for at least control/communication purposes. In some exemplary embodiments, the power supply 120 is used to provide a heating signal to the wire feeder 110 and/or to a contact tip 125 to deliver a heating signal to the cladding wire 101, where the heating signal is controlled such that it does not arc. The heating signal is a current signal that heats the wire 101 during the cladding process to aid in the deposition of the wire 101. In other exemplary embodiments, a cold wire can be used with no power supply 120, and the wire is melted using the laser. The heating signal from the power supply 120 can be directed from the contact tip 125 through the workpiece W and back to the power supply 120 (as shown) or the current can be simply passed through the contact tip 125 to heat the wire 101 with resistance in the contact tip 125 such that no current is passed through the workpiece W. As generally understood, the contact tip 125 is positioned such that it delivers the cladding wire 101 at an angle to the cladding operation and deposit the wire into the molten puddle.

The system 100 also includes a laser power supply 150 which provides power to a laser 155 within a torch assembly 160. The torch assembly 160 includes the laser 155 which directs a laser beam 156 to the surface of the workpiece W, and a nozzle 165 which directs a shielding gas to the surface of the workpiece W to shield the cladding operation. In a cladding operation, the laser beam 156 is used to heat the surface of the workpiece so as to create a molten surface to allow for the adhesion of the cladding layer from the wire 101. The shielding gas can be any type of shielding gas that benefits the cladding operation, and in exemplary embodiments can be 100% argon. The shielding gas can be supplied from a tank/source 140 and its flow can be controlled via a valve (not shown).

A controller 130 is used to control the operation of the system 100 and can be used to centrally control and sync each of the power supply 120, laser power supply 150 and wire feeder 110. The controller can be any type of computer/processor based system and while it is shown as a separate component in FIG. 1, it can be made integral to any of the power supply, laser power supply or wire feeder.

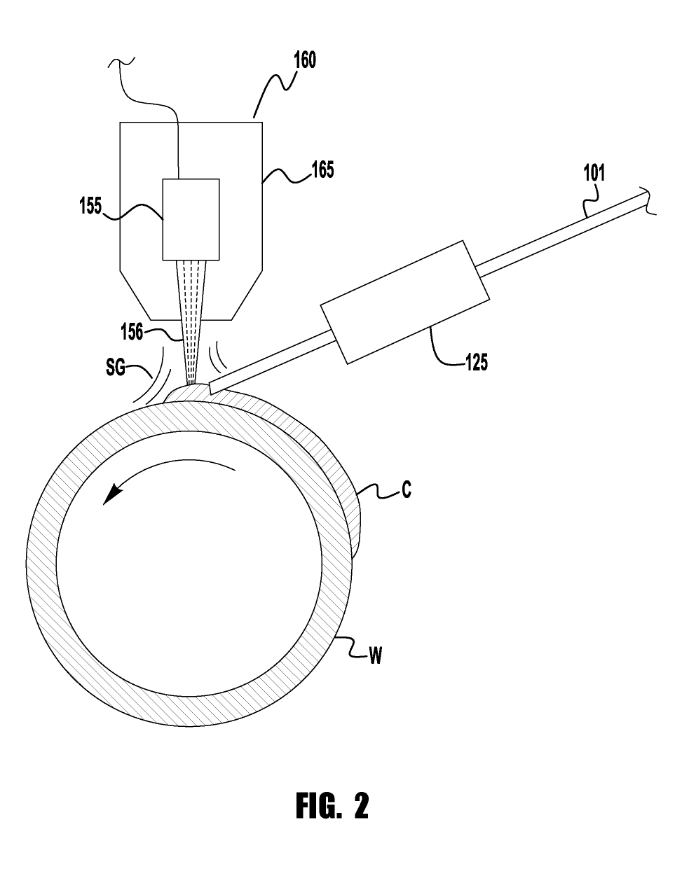

FIG. 2 depicts a closer view of the cladding operation. In the embodiment shown, the workpiece W is a pipe/tube or other type of object having a curved surface. Of course, embodiments of the invention can also be used on flat workpieces as well. As shown, the shielding gas SG exits the nozzle 165 to provide shielding while the clad layer C is deposited onto the surface of the workpiece W. As shown, during an exemplary embodiment of the cladding operation the workpiece W is rotated under the torch 160 so as to deposit the clad layer C in a helical pattern. It is noted that throughout this specification, the exemplary workpiece W in the figures is referred to as a “pipe.” However, it is understood and recognized that in some instances, small diameter pipe can be referred to as “tube.” Embodiments of the present invention are directed to cladding all manner of curved surfaces, including pipe, tube, etc. Thus the use of the term “pipe” is not intended to be limiting to larger diameter pipe, but rather merely exemplary.

As described above, embodiments of the present invention are directed to cladding, and more specific exemplary embodiments of the present invention relate to improving the deposition rate of a Nickel/Chromium/Molybdenum wire which meets the AWS ERNiCrMo-10 specifications. This AWS specification is set forth in the chart below, which shows the percentage by weight of the wire for the specified components. In exemplary embodiments, the wire is a solid wire. However, in other exemplary embodiments, other wire construction can be used, for example the wire 101 can be a metal cored wire. This wire is often used for cladding applications where the wire is deposited onto a surface to provide corrosion resistance. For example, the wire is used to provide a cladding layer on the exterior of pipe/tube surfaces. There are various commercial embodiments of this AWS specification wire, including wire manufactured by The Lincoln Electric Company of Cleveland, Ohio. This wire is identified as Techalloy® 622, and a typical composition for this product is also shown in the chart below.

When using these AWS consumables for a cladding operation, and in particular when cladding curved surfaces, the nickel in the consumable tends to react with oxygen and creates an appreciable amount of nickel-oxide. An increased amount of nickel-oxide tends to affect the flowability of the cladding deposit as it is formed and produces a green color on the surface of the clad layer. This is especially evident on smaller diameter curved surfaces. This creation of nickel oxide is often increased when cladding on curved surfaces, and in particular curved surfaces with a relatively small radius. This is due to the fact that it is difficult for the shielding gas to fully shield the operation when there is an increased curvature of the surface. Because of this, in typical cladding operations of pipe and other curved surfaces have a relatively slow speed and can use a high flow rate for shielding gas.

As shown in the chart below (Table 1), The AWS specification does not specify an amount of aluminum, and the Techalloy® typical composition has an aluminum content of 0.022% by weight. However, it has been discovered that increasing the aluminum content in wire of this AWS type can improved the performance of the cladding operation, and in particular when cladding curved surfaces. In fact, it has been discovered that increased amounts of aluminum can significantly increase the deposition speed for a cladding operation. The chart below shows an exemplary embodiment of an electrode with an increased amount of aluminum as described above. This composition is intended to be exemplary.

TABLE 1

| | Techalloy ® 622 | Techalloy ® 622 | Techalloy ® 622 |
|---|---|---|---|
| | specifications | typical | reformulated |
| | AWS ERNiCrMo-10 | composition | composition |
| % C | 0.015% max | 0.009% | 0.011% |
| % Mn | 0.01% | 0.21% | 0.14% |
| % Fe | 2.0-6.0% | 4.56% | 4.42-4.59% |
| % P | 0.02% max | 0.002% | 0.003-0.004% |
| % S | 0.010% max | 0% | 0% |
| % Si | 0.08% max | 0.03% | 0.01% |
| % Cu | 0.50% max | 0.002% | 0.002% |
| % Ni | Balance | 56.40% | 56.52-57.05% |
| % Co | 2.50% max | 0.027% | 0.062-0.065% |
| % Cr | 20.0-22.5% | 21.81% | 21.28-21.50% |
| % Mo | 12.5-14.5% | 13.6% | 13.4-13.8% |
| % V | 0.35% max | 0.027% | 0.023-0.024% |
| % W | 2.5-3.5% | 3.22% | 3.31% |
| % Other | 0.50% max | Bal. | Bal. |
| % Al | — | 0.022% | 0.154-0.157% |

To further explain benefits of embodiments of the present invention, a comparison of the cladding parameters is provided. Specifically, when using the above typical composition of Techalloy® 622, the cladding rotational speeds for the intended deposition rate, were typically limited to ˜29 mm/sec, when cladding a 1.25″ diameter substrate having a 0.240″ wall tube thickness. However, by increasing the amount of Al in the above composition from about 0.02% to between 0.154%-0.157% (approximately a 7-fold excess), deposition rates on the same underlying round substrate can be increased so that the rotational speed could be increased to ˜38 mm/sec, with rotational speeds as high as ˜44 mm/sec continuing to give acceptable results. Thus, exemplary embodiments of the present invention can provide at least a 30% increase in production, which is significant in a commercial environment.

As indicated above, surface analysis of clad material using the composition of a typical Techalloy® 622 or AWS compliant wire revealed the presence of NiOₓ in addition to oxides of Cr, Fe and Mn. However, surface analysis of the clad material using the Techalloy® 622 formulation with increased amounts of Al, revealed the presence of primarily AlOₓ and minimal CrOₓ on the surface, with minimal to no NiOₓ.

Without being held to any one theory or mode of operation, it is believed that adding controlled amounts of deoxidizing elements (e.g., Al, Ti, and perhaps Si, Mn, Zr), prevents the oxidation of nickel, allowing for better wetting / improved performance at higher travel speeds, thereby increasing productivity. It is believed that Al and Ti combine with oxygen faster than the other elements combine with oxygen present in the air, allowing the other elements to stay in the weld metal rather than oxidizing out as slag. With elements staying in solution in the weld pool, the weld metal wets better with the previous pass, thereby allowing increased rotational speeds and still producing an acceptable weld without defects.

This comports with information using Standard Reduction Potentials, reproduced below in Table 2.

TABLE 2

| Element | Reaction | E°/V |
|---|---|---|
| Al | Al³⁺ + 3e⁻ ⇄ Al₍ₛ₎ | −1.66 |
| Cr | Cr³⁺ + 3e⁻ ⇄ Cr₍ₛ₎ | −0.41 |
| Fe | Fe³⁺ + 3e⁻ ⇄ Fe₍ₛ₎ | −0.06 |
| Mn | Mn²⁺ + 2e⁻ ⇄ Mn₍ₛ₎ | −1.18 |
| Ni | Ni²⁺ + 2e⁻ ⇄ Ni₍ₛ₎ | −0.27 |
| Si | SiO₂₍ₛ₎ + 4H⁺ + 2e⁻ ⇄ Si₍ₛ₎ + 2H₂O | −0.86 |
| Ti | Ti²⁺ + 2e⁻ ⇄ Ti₍ₛ₎ | −1.63 |
| Zr | ZrO₂₍ₛ₎ + 4H⁺ + 4e⁻ ⇄ Zr₍ₛ₎ + 2H₂O | −1.43 |

If the electrode potential is positive, the reaction is the spontaneous reaction in the direction left to right. If the electrode potential is negative, the spontaneous reaction is in the opposite direction.

Thus, with embodiments of the present invention, the cladding operation is positively impacted by increasing the amount of aluminum to be higher than known formulations. In exemplary embodiments of the present invention, the amount of aluminum is in the range of 0.13-0.30 wt. %. Further, in exemplary embodiments, an increased amount of titanium is present, and is in the range of 0.03-0.20 wt. %.

In further exemplary embodiments, the amount of aluminum is at least 0.05% by weight of the wire, and in embodiments can be in the range of 0.05 to 0.3% by weight. In additional exemplary embodiments, the amount of aluminum is at least 0.1% by weight of the wire, and in further embodiments can be in the range of 0.1 to 0.3% by weight. In yet further exemplary embodiments, the amount of aluminum is at least 0.15% by weight of the wire, and more exemplary embodiments can be in the range of 0.15 to 0.3% by weight. Of course, it is noted that an upper limit of the amount of aluminum is limited by the maximum amount of other components allowed in the composition, Of course, aluminum should not consume the entirety of the other material amount, but in embodiments can encompass a majority of the other allowed materials.

With compositions described above, exemplary embodiments of the present invention can improve the deposition speed of a cladding operation on curved surfaces, for example pipes, etc. In fact, exemplary embodiments of the present invention can provide a cladding operation which can deposit clad onto a surface of a workpiece with travel speed (e.g., rotational speed of pipe) of at least approximately 32 mm/sec. In further exemplary embodiments, clad can be deposited onto a surface of a workpiece with travel speed (e.g., rotational speed of pipe) of at least approximately 33.5 mm/sec. In additional exemplary embodiments, clad can be deposited onto a surface of a workpiece with travel speed (e.g., rotational speed of pipe) of at least approximately 35 mm/sec, and even further exemplary embodiments, clad can be deposited onto a surface of a workpiece with travel speed (e.g., rotational speed of pipe) of at least approximately 38 mm/sec. Depending on the composition, in other embodiments the clad can be deposited onto a surface of a workpiece with travel speed (rotational speed of pipe) of at least approximately 44 mm/sec.

It is noted that benefits from embodiments of the present invention can be achieved on both flat and curved surfaces. However, with some exemplary embodiments, the travel speeds above can be achieved on curved surfaces, like pipes, etc., and especially small diameter pipes, for example, pipes with a diameter of 3 inches or less. Traditionally, with pipes of such small diameters the cladding process required slow speeds due to the need to ensure proper shielding on such curved surfaces, but with embodiments of the present invention, the above higher speeds can be achieved. This benefit comes from the improved chemistry of embodiments of the present invention, even though the amount of time the shielding gas is in contact with the curved surface is limited on smaller diameter pipes. Further, these increased speeds can also be achieved with larger diameter pipes (larger than 3 inches in diameter) along with a reduction in the amount of shielding gas needed. For example, in traditional cladding operations a 100% argon shielding gas a flow rate of 30-50 CFH is used. However, in exemplary embodiments of the present invention, a flow rate in the range of 10-25 CFH can be used, and in other exemplary embodiments the flow rate is in the range of 15-20 CFH. This flow rate can be used on both larger and smaller diameter workpieces/pipes depending on the desired properties of the cladding operation and is achievable due to the improved compositions described herein.

As shown previously in Table 1, the composition of an exemplary consumable is shown. The following Table 3 shows the composition of further exemplary embodiments.

TABLE 3

| | Exemplary Composition % by Weight |
|---|---|
| % C | 0.009 to 0.012% |
| % Mn | 0.12 to 16% |
| % Fe | 4.2-4.8% |
| % P | 0.003-0.004% |
| % S | 0% |
| % Si | 0.005 to 0.015% |
| % Cu | 0.0015 to 0.0025% |
| % Ni | 53-59% |
| % Co | 0.06-0.065% |
| % Cr | 20.5-22% |
| % Mo | 12.5-14.5% |
| % V | 0.022-0.025% |
| % W | 3 to 3.5% |
| % Al | 0.1-0.3% |
| % Ti | 0.015 to 0.2% |
| % Zr | 0.0005 to 0.002% |
| % Other | Bal. |

In further embodiments, the aluminum can be in the range of 0.05 to 0.3% by weight, and in other embodiments it can be in the range of 0.15 to 0.3% by weight. Further, the titanium can be in the range of 0.03 to 0.1% by weight. Further, as explained previously embodiments of the present invention are enhanced by increasing amounts of other oxidizing materials, other than nickel. These other oxidizing materials can include Al, Ti, Si, Mn, and Zr, and any combination thereof. While aluminum has been found to be a particularly useful oxidizing material in embodiments of the present invention, these other oxidizers can also provide a benefit. In exemplary embodiments, the total percentage weight of the combination of oxidizing agents used, other than nickel, is in the range of 0.2 to 0.5% by weight. In further exemplary embodiments, the combination is in the range of 0.25 to 0.4%by weight. In additional exemplary embodiments, the combined weight percentage is in the range of 0.28 to 0.35%. For example, if a consumable contains each of Al, Ti, Si, Mn, and Zr, the combination of each of these oxidizers, collectively, is in the range of 0.2 to 0.5% by weight, or 0.25 to 0.4% by weight, or 0.28 to 0.35% by weight depending on the desired performance. Further, in another example, which only uses a subset of these oxidizers (e.g., only Al, Ti, and Si; or Al, Ti, Mn and Zr; etc.), the combination of each of these oxidizers, collectively, is in the range of 0.2 to 0.5% by weight, or 0.25 to 0.4% by weight, or 0.28 to 0.35% by weight depending on the desired performance. Of course, other combinations can be used to minimize the creation of nickel-oxide.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. A cladding consumable; comprising:
nickel in the range of 53 to 59% by weight;
chromium in the range of 20.5 to 22% by weight;
molybdenum in the range of 12.5 to 14.5% by weight; and
aluminum in the range of 0.05 to 0.3% by weight.

2. The consumable of claim 1, wherein said consumable is a solid wire consumable.

3. The consumable of claim 1, wherein said consumable is a laser cladding consumable.

4. The consumable of claim 1, wherein said aluminum is in the range of 0.1 to 0.3% by weight.

5. The consumable of claim 1, wherein said aluminum is in the range of 0.15 to 0.3% by weight.

6. The consumable of claim 1, further comprising titanium in the range of 0.03 to 0.2% by weight.

7. The consumable of claim 1, further comprising titanium in the range of 0.03 to 0.1% by weight.

8. The consumable of claim 1, further comprising at least one of titanium, silicone, manganese, and zirconium.

9. The consumable of claim 1, further comprising at least one of titanium, silicone, manganese, and zirconium, and a total of said at least one of said titanium, silicone, manganese, and zirconium and aluminum is in the range of 0.2 to 0.5% by weight.

10. The consumable of claim 1, further comprising at least one of titanium, silicone, manganese, and zirconium, and a total of said at least one of said titanium, silicone, manganese, and zirconium and aluminum is in the range of 0.25 to 0.4% by weight.

11. The consumable of claim 1, further comprising at least one of titanium, silicone, manganese, and zirconium, and a total of said at least one of said titanium, silicone, manganese, and zirconium and aluminum is in the range of 0.28 to 0.35% by weight.

12. A laser cladding consumable, said consumable comprising:
carbon in the range of 0.009 to 0.012% by weight;
manganese in the range of 0.12 to 0.16% by weight;
iron in the range of 4.2 to 4.8% by weight;
phosphorus in the range of 0.003 to 0.004% by weight;
silicone in the range of 0.005 to 0.015% by weight;
copper in the range of 0.0015 to 0.0025% by weight;
nickel in the range of 53 to 59% by weight;
cobalt in the range of 0.06 to 0.065% by weight;
chromium in the range of 20.5 to 22% by weight;
molybdenum in the range of 12.5 to 14.5% by weight;
vanadium in the range of 0.022 to 0.025% by weight;
tungsten in the range of 3 to 3.5% by weight;
aluminum in the range of 0.1 to 0.3% by weight;
titanium in the range of 0.015 to 0.2% by weight; and
zirconium in the range of 0.0005 to 0.002% by weight,
wherein said consumable is a solid consumable.

13. A method of laser cladding; said method comprising:
providing a consumable to a workpiece where said consumable comprises nickel in the range of 53 to 59% by weight, chromium in the range of 20.5 to 22% by weight, molybdenum in the range of 12.5 to 14.5% by weight, and aluminum in the range of 0.05 to 0.3% by weight;
directing a laser beam at said workpiece to heat said workpiece;
heating at least one of said workpiece and said consumable to deposit a cladding layer on a surface of said workpiece;
depositing said consumable on said workpiece at a travel speed of at least 32 mm/sec; and
providing a shielding gas during said depositing of said consumable;
wherein said workpiece has a curved surface.

14. The method of claim 13, wherein said workpiece is a pipe having an outside diameter of no more than 3 inches.

15. The method of claim 13, wherein said shielding gas is provided at a flow rate in the range of 10 to 25 CFH.

16. The method of claim 13, wherein said shielding gas is provided at a flow rate in the range of 15 to 20 CFH.

17. The method of claim 13, wherein said travel speed is at least 33.5 mm/sec.

18. The method of claim 13, wherein said travel speed is at least 35 mm/sec.

19. The method of claim 13, wherein said travel speed is at least 38 mm/sec.

20. The method of claim 13, wherein said travel speed is at least 44 mm/sec.
